(19) United States
(12) Patent Application Publication
(10) Pub. No.: US 2026/0156306 A1
(43) Pub. Date: Jun. 4, 2026

(54) IN-FLIGHT ENTERTAINMENT SYSTEMS WITH CENTRALIZED BLUETOOTH CONTROLLER FOR DYNAMIC LEVELING OF INTERFERENCE

(71) Applicant: Thales Avionics, Inc., Irvine, CA (US)

(72) Inventors: Kevin JUDD, Irvine, CA (US); Ton DO, Corona, CA (US)

(21) Appl. No.: 18/964,426

(22) Filed: Nov. 30, 2024

(51) Int. Cl. H04N 21/214; H04W 52/38

(52) U.S. Cl. CPC H04N 21/2146; H04W 52/383

(57) ABSTRACT

A vehicle entertainment system, such as an aircraft entertainment system, includes a centralized Bluetooth radio manager that is communicatively connected to video display units (VDUs) with Bluetooth radios at passenger seats within a vehicle cabin. The centralized Bluetooth radio manager performs operations to obtain from each VDU among a group of the VDUs, information identifying a detected set of the VDUs having Bluetooth radios transmitting signals that are received by the Bluetooth radio of the VDU. Responsive to the information obtained from the group of the VDUs identifying different numbers of VDUs in their respective detected sets, the operations control at least one of the VDUs in the group to change transmission power of its Bluetooth radio in a direction that decreases difference between the numbers of VDUs in their respective detected sets which are identified in further information subsequently obtained from the group of the VDUs.

### FIELD OF THE INVENTION

The present disclosure relates to aircraft-based in-flight entertainment systems that communicate with mobile terminals using Bluetooth radio transmitters.

### BACKGROUND

Radio interference in aircraft cabins is becoming a growing concern due to the increasing number of radio transmitters present in the cabin. With the rise of technology and the widespread use of personal electronic devices, there are now many sources of radio frequency (RF) signals in an aircraft cabin, such as seat video display units having Bluetooth radios, passenger electronic devices having both Bluetooth and WiFi radios, WiFi access points, and other wireless communication devices.

The proliferation of such wireless devices operating simultaneously, usually within the industrial, scientific and medical (ISM) radio band, and with unsynchronized use of the radio resources, can result in levels of communication interference that degrade or intermittently prevent device communications and may interfere with the functioning of other electronic systems or components in the aircraft. Radio transceivers are typically programmed to respond to degradation of their communication link quality by increasing their transmission power level. However, these operations can result in a rapid escalation of the signal noise floor within the cabin and further increase levels of communication interference and degraded/interrupted device operation.

### SUMMARY

Some embodiments of the present disclosure are directed to a vehicle entertainment system, which can be an in-flight entertainment system. The system includes a centralized Bluetooth radio manager that is communicatively connected to video display units (VDUs) which are located at passenger seats within a vehicle cabin. Each of the VDUs includes a Bluetooth radio. The Bluetooth radios may be integrated within the VDUs or may be separate therefrom but communicatively connected to the VDUs. The centralized Bluetooth radio manager includes a network interface that communicates with the VDUs through a vehicle cabin network, and a processing circuit coupled to the network interface and configured to perform operations. Some operations obtain from each VDU among a group of the VDUs, information identifying a detected set of the VDUs having Bluetooth radios transmitting signals that are received by the Bluetooth radio of the VDU. Responsive to the information obtained from the group of the VDUs identifying different numbers of VDUs in their respective detected sets, some further operations control at least one of the VDUs in the group to change transmission power of its Bluetooth radio in a direction that decreases difference between the numbers of VDUs in their respective detected sets which are identified in further information subsequently obtained from the group of the VDUs by the processing circuit.

As will be explained below with regard to some further embodiments, the operations can be repetitively performed across the VDUs in a seating section and/or the entire cabin to control the transmission power levels of the Bluetooth radios in various ways that can reduce radio interference hotspots and/or provide more equalization of the transmission power levels allowed for the Bluetooth radios, which may improve the reliability and/or quality of communications by the Bluetooth radios.

Other vehicle entertainment systems, centralized Bluetooth radio managers, methods, and computer program products according to embodiments of the inventive subject matter will be or become apparent to one with skill in the art upon review of the following drawings and detailed description. It is intended that all such additional vehicle entertainment systems, centralized Bluetooth radio managers, methods, and computer program products be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 illustrates an aircraft fuselage containing an IFE system that provides entertainment services to passengers and includes a centralized Bluetooth radio manager which operates according to one or more embodiments of the present disclosure;

FIG. 2 is a combined flowchart and data flow diagram of operations performed by the centralized Bluetooth radio manager to control levels of transmission power from Bluetooth radios of video display units located throughout seating sections and/or the entire cabin in accordance with some embodiments of the present disclosure; and

FIG. 3 is a block diagram of components of the centralized Bluetooth radio manager of FIGS. 1 and 2 which are configured to operate in accordance with some embodiments of the present disclosure.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

An aircraft cabin can have a very high density of Bluetooth radios that are simultaneously using shared frequency resources for communications. The resulting co-channel interference can degrade or preclude wireless communications within the aircraft cabin and may degrade or intermittently prevent operation of the IFE system and/or other aircraft systems or components. Moreover, the Bluetooth radios would normally respond to increasing levels of interference by further increasing their transmission power levels and which, undesirably, further increases the levels of interference and degraded/interrupted device operation. Although Bluetooth radios have frequency hop capability which can help overcome some interference, in high interference locations communication capabilities can be degraded/interrupted.

Various embodiments of the present disclosure are directed to innovative operations and methods for centrally controlling Bluetooth radios to control the level of radiated power in an aircraft cabin.

As will be explained in further detail below, some embodiments are directed to an aircraft inflight entertainment (IFE) system that includes a centralized Bluetooth radio manager which is communicatively connected to Bluetooth radios located in video display units (VDUs) at passenger seats within an aircraft cabin. The centralized Bluetooth radio manager operates to control the transmission power levels of the Bluetooth radios in various ways that can reduce radio interference hotspots in the cabin and/or provide more equalization of the power levels that are received by the Bluetooth radios from transmissions by other proximately located Bluetooth radios. These operations may improve the reliability and quality of communications by the Bluetooth radios.

Although embodiments herein are primarily described in the context of an IFE system deployed onboard an aircraft, the invention is not limited thereto. Instead, these and other related embodiments may be used to control the level of radiated power from Bluetooth radios located in other types of vehicles, including without limitation, trains, automobiles, cruise ships, and buses, and in other non-vehicle installations, including without limitation, hospital rooms (e.g., operating room), meeting rooms, sports stadiums, etc.

The Bluetooth radios can be configured to transmit and receive radio frequency signals in an unlicensed band, such as the ISM band, and/or in a licensed band. As used herein, the term “ISM band” refers to one or more frequency ranges that are reserved internationally for the use of radio frequency energy for unlicensed and/or licensed communications. The term “band” can refer to one continuous frequency range or a plurality of non-continuous frequency ranges that are defined by the ITU Radio Regulations for ISM communications.

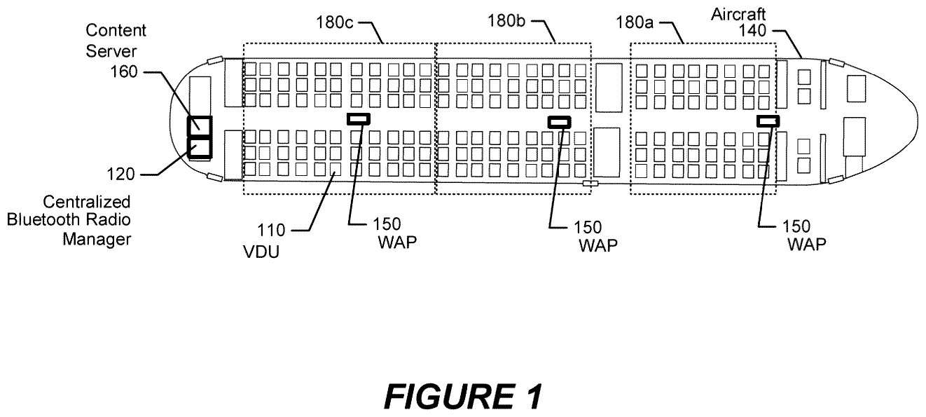

FIG. 1 illustrates an aircraft fuselage 140 containing an IFE system that provides entertainment services to passengers. The IFE system includes a content server 160 that streams and/or downloads electronic content through a wired network, e.g., Ethernet, and/or through WiFi radios within wireless access points (WAPs) 150 to other WiFi radios within video display units (VDUs) 110 mounted to structures in the aircraft, including to seatbacks, seat armrests/frames, bulkheads, overhead structures, etc., and to WiFi radios within passenger devices carried on-board by passengers, such as smart phones, tablet computers, laptop computers, etc.

The VDUs 110 may each contain one or more Bluetooth radios that wirelessly communicate through RF signaling with Bluetooth radios within passenger devices and/or with passenger control units (PCUs) that can be releasable docked to an armrest docking station and/or a docking station connected to some/all of the VDUs 110.

When a Bluetooth radio is within a VDU 110, the Bluetooth radio may be incorporated within the housing that at least partially encloses electronic circuitry that provides functionality for the VDU 110, e.g., display device, video processing circuitry, user interface circuitry, network interface circuitry, etc. The Bluetooth radios are not necessarily within the VDUs 110 and may be located elsewhere and community connected to the electronic circuitry provides functionality for the VDU 110, such as mounted elsewhere in a seat or in a seat electronics box, e.g., located underneath a seat, or in an overhead panel. The Bluetooth radios may alternatively or additionally be located elsewhere and connected to the VDUs through wireless and/or wired connections, such as if the Bluetooth radio has a wired connection to VDU and provides Bluetooth connection to passenger devices.

In accordance with present embodiments, the IFE system further includes a centralized Bluetooth radio manager 120 that is communicatively connected to the Bluetooth radios located with the VDUs 110 at passenger seats. The centralized Bluetooth radio manager 120 includes a network interface that communicates with the Bluetooth radios through a vehicle cabin network and a processing circuit coupled to the network interface and configured to perform operations according to embodiments disclosed herein. The processing circuit can include at least one processor coupled to at least one memory storing instructions that when executed causes the at least one processor to perform the various operations.

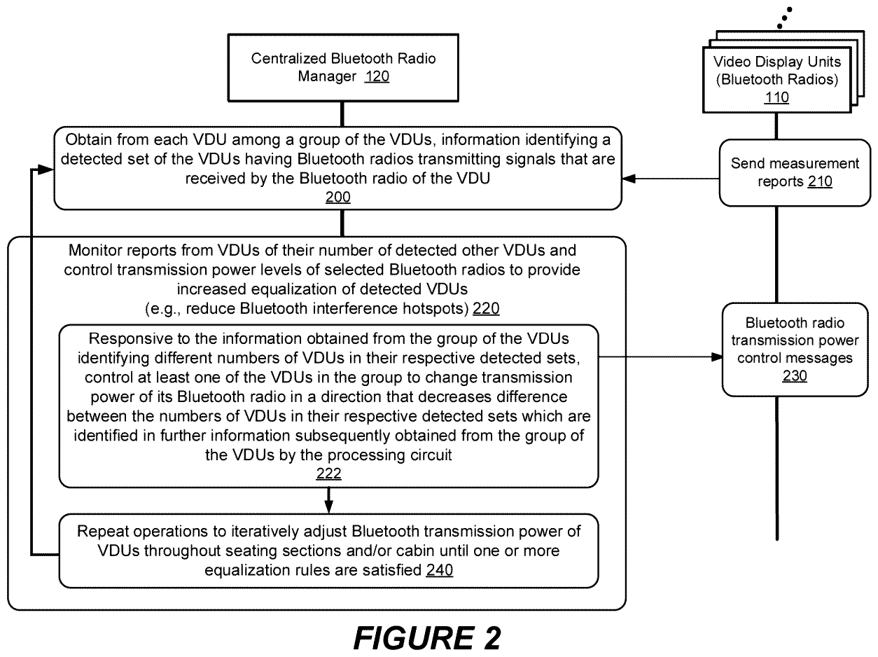

FIG. 2 is a combined flowchart and data flow diagram of operations performed by the centralized Bluetooth radio manager 120 to control levels of transmission power from Bluetooth radios throughout seating sections and/or the entire cabin in accordance with some embodiments of the present disclosure.

Referring to FIG. 2, the centralized Bluetooth radio manager 120 obtains 200 information from VDUs 110 in the cabin. For each of the VDUs 110, the information identifies a set of VDUs having Bluetooth radios that are transmitting signals which are received by the Bluetooth radio of the VDU. The centralized Bluetooth radio manager 120 can monitor 220 information (e.g., report messages, heartbeat message, etc.) received from other VDUs indicating their numbers of detected other VDUs and, responsive thereto, control transmission power levels Bluetooth radios of selected VDUs to provide increased equalization of the numbers of detected VDUs and/or reduce radio interference hotspots.

Thus, for example, the information from a first VDU may include a list of identifiers of what VDUs (or Bluetooth radios of the VDUs) which are detected by the first VDU through Bluetooth signaling received by the Bluetooth radio of the first VDU. Similarly, information is obtained from a second VDU that is located in the same seating row or another spaced apart seating row relative to the first VDU and which identifies a set of VDUs having Bluetooth radios that are transmitting signals which are received by the Bluetooth radio of the second VDU. The centralized Bluetooth radio manager 120 can determine through the information obtained from VDUs located throughout a defined seating section or throughout the cabin how many other VDUs are respectively detected. While a VDU can be expected to detect Bluetooth transmissions from a closely located VDU, when it also detects Bluetooth transmissions from a remotely located VDU (e.g., 10 seating rows away) that can indicate to the centralized Bluetooth radio manager 120 that the Bluetooth radio of the remotely located VDU is transmitting at an excessively high power level and which should be decreased to reduce interference to Bluetooth communications by the detecting VDU and other closely located VDUs.

The centralized Bluetooth radio manager 120 can determine from comparison of the relative numbers of VDUs detected by various VDUs in the defined seating section or throughout the cabin whether the transmission power of the Bluetooth radios of one or more of the VDUs should be changed to, for example, reduce radio interference hotspots in the cabin and/or provide more equalization of the power levels that are received by the Bluetooth radios from transmissions by other proximately located Bluetooth radios and, thereby, improve the reliability of communications by the Bluetooth radios.

In some operational embodiments, responsive to the information obtained from the group of the VDUs identifying different numbers of VDUs in their respective detected sets, control 220 at least one of the VDUs in the group to change transmission power of its Bluetooth radio in a direction that decreases difference between the numbers of VDUs in their respective detected sets which are identified in further information subsequently obtained from the group of the VDUs by the processing circuit. Operations to control the transmission power of the Bluetooth radio of another VDU can include to send 230 thereto a transmission power control message, e.g., through a wired cabin network (e.g., Ethernet) or through a wireless cabin network (e.g., WiFi, cellular, etc.).

The centralized Bluetooth radio manager 120 can sequentially analyze the number of detected VDUs indicated in information from individual VDUs or from a group of VDUs, e.g., closely located VDUs in the cabin, to decide whether the Bluetooth transmission power level of one or more of the detected VDUs should be changed. The centralized Bluetooth radio manager 120 can therefore operate 240 to repeat the operations 200-230 to iteratively adjust the Bluetooth transmission power of certain VDUs throughout one or more seating sections and/or the cabin until one or more equalization rules are satisfied.

An example operational embodiment includes that after an initial bootup of the centralized Bluetooth radio manager 120 and VDUs, the centralized Bluetooth radio manager 120 uses an algorithm to optimize the number of VDUs that various other VDUs throughout a section or cabin can detect. The centralized Bluetooth radio manager 120 can respond to a VDU, e.g., one that is more centrally located in the cabin, detecting more than a threshold number of other VDUs by sending a command to the farthest away detected VDU or a group of furthest ones of the detected VDUs to each lower their Bluetooth radio power by a defined amount, e.g., one power level step.

In one example implantation, the centralized Bluetooth radio manager 120 starts using information reported by VDUs located at the end region(s) of the cabin seating (e.g., first row and/or last row of a seating section or the cabin) and repeat the operations using information subsequently reported by VDUs that are located progressing towards a middle region of the seating section and/or cabin. The seating section may correspond to the entire cabin or to one of a plurality of seating sections that are spaced apart by intervening galley area(s) and/or lavatory area(s)).

The VDUs continue to report information identifying the presently detected set of VDUs to the centralized Bluetooth radio manager 120, e.g., as part of heartbeat messages which may indicate the number and identifiers of detected VDUs. The centralized Bluetooth radio manager 120 responsively continues to adjust the Bluetooth transmission power levels as needed to lower power by, e.g., small power level steps, until the one or more equalization rules are satisfied.

Accordingly, in some embodiments, the centralized Bluetooth radio manager 120 repetitively performs the operations 200-240 sequentially starting with the VDUs located at passenger seats in a first end region of a defined cabin seating section and progressing toward the VDUs located at passenger seats in a middle region of the defined seating section, to control transmission power of the Bluetooth radios of those VDUs in a direction that decreases difference between the numbers of VDUs in their respective detected sets which are identified in information obtained from those VDUs.

The centralized Bluetooth radio manager 120 can then continue to sequentially perform the repetitive operations from the VDUs located at the passenger seats in the middle region of the defined seating section and progressing toward the VDUs located at passenger seats in a second end region of the defined seating section, to control transmission power of the Bluetooth radios of those VDUs in a direction that decreases difference between the numbers of VDUs in their respective detected sets which are identified in information obtained from those VDU. In this example, the second end region can be located opposite to the first end region relative to the middle region.

As alternative operations to this example implementation, the centralized Bluetooth radio manager 120 can continue BT transmission power management from an opposite end region (e.g., first row or last row of defined cabin seating section) and progress toward the middle region (e.g., middle row of cabin seating section). More particularly, the centralized Bluetooth radio manager 120 can continue to sequentially perform the repetitive operations 200-240 from the VDUs located at passenger seats in a second end region of the defined seating section and progressing toward the VDUs located at the passenger seats in the middle region of the defined seating section, to control transmission power of the Bluetooth radios of those VDUs in a direction that decreases difference between the numbers of VDUs in their respective detected sets which are identified in information obtained from those VDUs. In this example, the second end region can be located opposite to the first end region relative to the middle region.

In a further example, the centralized Bluetooth radio manager 120 commands the farthest VDUs, that are among the list of detected VDUs above the desired number of detected units, to lower their radio power by a small percentage. The operations may, for example, start at the farthest ends of the vehicle cabin and work towards the center. In an example implementation, the centralized Bluetooth radio manager 120 selects a VDU in the group of the VDUs based on the VDU being located in an end region or a middle region of a defined cabin seating section. Responsive to determining the information obtained from the selected VDU contains a number of VDUs in the detected set that is more than a threshold number greater than is contained in the information obtained from another one of the VDUs in the group, the manager 120 identifies in the information obtained from the selected VDU a plurality of the VDUs in the detected set that are located most distant from the selected VDU, and responsively controls the most distant plurality of the VDUs to decrease transmission power of their Bluetooth radios to decrease the number of VDUs in the detected set identified in further information subsequently obtained from the selected VDU by the processing circuit.

In a further operational implementation, the centralized Bluetooth radio manager 120 responds to determining that further information which is subsequently obtained from the selected VDU by the processing circuit contains a number of VDUs in the detected set that is more than a threshold number greater than is contained in further information that is also subsequently obtained from another one of the VDUs in the group, by: 1) identifying in the further information subsequently obtained from the selected VDU a plurality of the VDUs in the detected set that are located less distant from the selected VDU than the most distant plurality of the VDUs; and 2) controlling the less distant plurality of the VDUs to decrease transmission power of their Bluetooth radios to decrease the number of VDUs in the detected set identified in next further information next subsequently obtained from the selected VDU by the processing circuit.

The operations and/or rules used to control Bluetooth power may differ depending upon in which of a plurality of seating sections a VDU is located. For example, FIG. 1 illustrates seating sections 180a-c, where sections 180a and 180b that are spaced apart by intervening galley area(s) and/or lavatory area(s)). Because of the intervening areas between sections 180a and 180b the Bluetooth radios of the VDUs located in the sections 180a should be controlled by separate steps in the process from such control of VDUs in section 180b. For example, the centralized Bluetooth radio manager 120 may perform power equalization of VDUs in section 180a and then perform such power equation for VDUs in section 180b. The operations used to control Bluetooth power and/or the rules used by the operations may be defined differently depending upon what seating section a VDU is located, based on a class of service defined for the seating section, and/or based on a determining that passenger using (being served by) a VDU has a preferentially treated status.

According to an example implementation, the centralized Bluetooth radio manager 120 repetitively 240 performs the operations 200-230 sequentially starting with the VDUs located at passenger seats in a defined cabin seating section and progressing toward the VDUs located at passenger seats in a more distant region of the defined seating section, to control transmission power of the Bluetooth radios of those VDUs in a direction that decreases difference between the numbers of VDUs in their respective detected sets which are identified in information obtained from those VDUs. The operation to control 222 transmission power of the Bluetooth radios of those VDUs can include to reduce by a first step size the transmission power of the Bluetooth radios of VDUs that are located in a defined part of the cabin seating section, and alternatively, reduce by a second step size the transmission power of the Bluetooth radios of VDUs that are not located in the defined part of the cabin seating section, wherein the second step size is greater than the first step size.

According to an example implementation, the centralized Bluetooth radio manager 120 repetitively 240 performs the operations 200-230 sequentially starting with the VDUs located at passenger seats in a defined cabin seating section and progressing toward the VDUs located at passenger seats in a more distant region of the defined seating section, to control transmission power of the Bluetooth radios of those VDUs in a direction that decreases difference between the numbers of VDUs in their respective detected sets which are identified in information obtained from those VDUs. The operation to control 222 transmission power of the Bluetooth radios of those VDUs can include to reduce by a first step size the transmission power of the Bluetooth radios of VDUs that are determined to be serving passengers having a preferentially treated status, and, alternatively, reduce by a second step size the transmission power of the Bluetooth radios of VDUs that are determined to not be serving passengers having the preferentially treated status, wherein the second step size is greater than the first step size.

The centralized Bluetooth radio manager 120 may start the operational process by initially commanding the start the Bluetooth radios of the VDUs to perform their transmissions at the highest allowable level, e.g., command maximum transmission power level. Through the repetitive operations which can be iteratively performed throughout the cabin, the centralized Bluetooth radio manager 120 can then step-wise decrease the transmission power levels of the Bluetooth radios until the level of RF interference falls within the capability of the BT frequency hopping technology so as to provide reliable Bluetooth communications throughout a seating section and/or the cabin.

According to an example implementation, the centralized Bluetooth radio manager 120 sends max power commands to the VDUs to set transmission power of their Bluetooth radios to the highest level allowed for the Bluetooth radios. The centralized Bluetooth radio manager 120 operates to repetitively perform the operations 200-230 sequentially starting with the VDUs located at passenger seats in a defined cabin seating section and progressing toward the VDUs located at passenger seats located in a more distant region of the defined seating section, to control transmission power of the Bluetooth radios of those VDUs in a direction that decreases difference between the numbers of VDUs in their respective detected sets which are identified in information obtained from those VDUs. The centralized Bluetooth radio manager 120 repeats cycles of the repetitive performance of the operations 200-230 to control transmission power of the Bluetooth radios of the VDUs to decrease difference between the numbers of VDUs in their respective detected sets which are identified in information obtained from those VDUs, until the differences satisfy a defined rule.

Referring further to FIG. 2, the centralized Bluetooth radio manager 120 may obtain information from the VDUs by sending a request message to each of the VDUs requesting report of the information to the centralized Bluetooth radio manager, e.g., by polling the VDUs.

How frequently the centralized Bluetooth radio manager 120 requests information from the VDUs can be adapted based on various factors to increase or ensure stability of the processes for adapting Bluetooth transmission power while sufficiently maintaining existing (active) Bluetooth communication connections between VDUs and passenger electronic devices (e.g., laptop computers, tablet computers, smart phones, wireless headphones, etc.), passenger control units, etc.

For example, the centralized Bluetooth radio manager 120 may operate to decrease a periodic rate at which it sends the request message to a selected one of the VDUs based on at least a threshold difference identified between a present number of VDUs identified in the information presently reported by the selected VDU to the centralized Bluetooth radio manager and a previous number of VDUs identified in the information previously reported by the selected VDU to the centralized Bluetooth radio manager.

Alternatively, the centralized Bluetooth radio manager 120 may operate to increase a periodic rate at which it sends the request message to a selected one of the VDUs based on at least a threshold difference between the number of VDUs identified in the information reported by the selected VDU to the centralized Bluetooth radio manager and the number of VDUs identified in the information reported by another selected one of the VDUs to the centralized Bluetooth radio manager.

As an alternative or in addition to polling the information from the VDUs, the centralized Bluetooth radio manager 120 may receive a periodic report generated by each of the VDUs containing the information, e.g., the VDUs periodically push the information to the centralized Bluetooth radio manager 120.

The amount of RF interference caused by Bluetooth transmissions to other Bluetooth communications, depends upon characteristics of the Bluetooth transmissions. For example, active Bluetooth data connections between Bluetooth radios can cause greater interference than some other shorter duration and/or lower bandwidth transmissions, such as Bluetooth advertisements.

Thus, in some further embodiments the centralized Bluetooth radio manager 120 processes the information obtained from each VDU among the group of the VDUs to identify, among the detected set of the VDUs having Bluetooth radios transmitting signals that are received by the Bluetooth radio of the VDU, which of the received signals are indicative of an active Bluetooth data connection between the Bluetooth radio of one of the set of VDUs and another Bluetooth device (e.g., passenger electronic device (e.g., laptop computer, tablet computer, smart phone, wireless headphones, etc.), passenger control unit, etc. The centralized Bluetooth radio manager 120 determines (used in operation 222) the number of VDUs in the detected set by counting the identified active Bluetooth data connections. The centralized Bluetooth radio manager 120 may determine the number of VDUs in the detected set to exclude from the count any of the received signals that are indicative of a Bluetooth advertisement.

### Example Centralized Bluetooth Radio Manager:

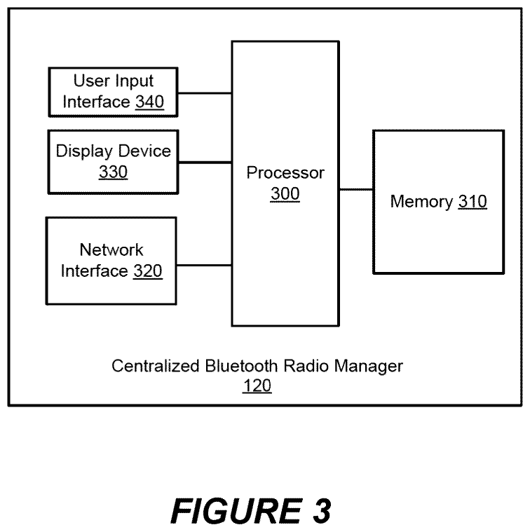

FIG. 3 is a block diagram of components of the centralized Bluetooth radio manager 120 of FIGS. 1 and 2 which are configured to operate in accordance with some embodiments of the present disclosure. The manager 120 includes a processor 300, a memory 310, and a network interface 320 which may include a wireless and/or a wired network communication (e.g., Ethernet) capability. When the network interface 320 is configured for wireless communication, it may include, but is not limited to, a Bluetooth transceiver, a WLAN transceiver (IEEE 802.11A-D, IEEE 802.11A-C, or other IEEE 802.11), a LTE, 3GPP 5G NR, or other cellular transceiver, or other RF communication transceiver configured to communicate with the VDUs, Bluetooth radios located with the VDUs, and the WAPs.

The processor 300 may include one or more data processing circuits, such as a general purpose and/or special purpose processor (e.g., microprocessor and/or digital signal processor) that may be collocated or distributed across one or more networks. The processor 300 is configured to execute computer program code in the memory 310, described below as a non-transitory computer readable medium, to perform at least some of the operations described herein as being performed by an access control computer. The computer program code when executed by the processor 300 causes the processor 300 to perform operations in accordance with one or more embodiments disclosed herein for the manager 120. The manager 120 may further include a user input interface 340 (e.g., touch screen, keyboard, keypad, etc.) and a display device 330.

As explained above, the Bluetooth radios of the VDUs can identify what other Bluetooth radios are detected, and may operate to measure received signal strength (e.g., to generate received signal strength indicator (RSSI) values) and/or estimate channel-state/link-quality (e.g., signal-to-interference-plus-noise ratio (SNIR)) by measuring forward error correction (FEC) and/or cyclic redundancy check (CRC) error rates. The RSSI can be measured as the total received wideband power measured by the receiving Bluetooth radio within a defined bandwidth. The received signal strength may be determined as a linear average of the total received power in the measured bandwidth over a defined number of resource blocks or time periods.

### Further Definitions and Embodiments

In the above description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A vehicle entertainment system comprising:
a centralized Bluetooth radio manager communicatively connected to video display units (VDUs) at passenger seats within a vehicle cabin, wherein each of the VDUs includes a Bluetooth radio, and the centralized Bluetooth radio manager comprises:
a network interface that communicates with the VDUs through a vehicle cabin network;
a processing circuit coupled to the network interface and configured to perform operations comprising to:
obtain from each VDU among a group of the VDUs, information identifying a detected set of the VDUs having Bluetooth radios transmitting signals that are received by the Bluetooth radio of the VDU; and
responsive to the information obtained from the group of the VDUs identifying different numbers of VDUs in their respective detected sets, control at least one of the VDUs in the group to change transmission power of its Bluetooth radio in a direction that decreases difference between the numbers of VDUs in their respective detected sets which are identified in further information subsequently obtained from the group of the VDUs by the processing circuit.

2. The vehicle entertainment system of claim 1, wherein the processing circuit is further configured to:
repetitively perform the operations sequentially starting with the VDUs located at passenger seats in a first end region of a defined cabin seating section and progressing toward the VDUs located at passenger seats in a middle region of the defined seating section, to control transmission power of the Bluetooth radios of those VDUs in a direction that decreases difference between the numbers of VDUs in their respective detected sets which are identified in information obtained from those VDUs.

3. The vehicle entertainment system of claim 2, wherein the processing circuit is further configured to:
continue to sequentially perform the repetitive operations from the VDUs located at the passenger seats in the middle region of the defined seating section and progressing toward the VDUs located at passenger seats in a second end region of the defined seating section, to control transmission power of the Bluetooth radios of those VDUs in a direction that decreases difference between the numbers of VDUs in their respective detected sets which are identified in information obtained from those VDUs,
wherein the second end region is located opposite to the first end region relative to the middle region.

4. The vehicle entertainment system of claim 2, wherein the processing circuit is further configured to:
continue to sequentially perform the repetitive operations from the VDUs located at passenger seats in a second end region of the defined seating section and progressing toward the VDUs located at the passenger seats in the middle region of the defined seating section, to control transmission power of the Bluetooth radios of those VDUs in a direction that decreases difference between the numbers of VDUs in their respective detected sets which are identified in information obtained from those VDUs,
wherein the second end region is located opposite to the first end region relative to the middle region.

5. The vehicle entertainment system of claim 1, wherein the operations of the processing circuit further comprise to:
select a VDU in the group of the VDUs based on the VDU being located in an end region or a middle region of a defined cabin seating section; and
responsive to determining the information obtained from the selected VDU contains a number of VDUs in the detected set that is more than a threshold number greater than is contained in the information obtained from another one of the VDUs in the group,
identify in the information obtained from the selected VDU a plurality of the VDUs in the detected set that are located most distant from the selected VDU; and
control the most distant plurality of the VDUs to decrease transmission power of their Bluetooth radios to decrease the number of VDUs in the detected set identified in further information subsequently obtained from the selected VDU by the processing circuit.

6. The vehicle entertainment system of claim 5, wherein the operations of the processing circuit further comprise to:
responsive to determining the further information subsequently obtained from the selected VDU by the processing circuit contains a number of VDUs in the detected set that is more than a threshold number greater than is contained in further information that is also subsequently obtained from another one of the VDUs in the group,
identify in the further information subsequently obtained from the selected VDU a plurality of the VDUs in the detected set that are located less distant from the selected VDU than the most distant plurality of the VDUs; and
control the less distant plurality of the VDUs to decrease transmission power of their Bluetooth radios to decrease the number of VDUs in the detected set identified in next further information next subsequently obtained from the selected VDU by the processing circuit.

7. The vehicle entertainment system of claim 1, wherein the operations of the processing circuit further comprise to:
repetitively perform the operations sequentially starting with the VDUs located at passenger seats in a defined cabin seating section and progressing toward the VDUs located at passenger seats in a more distant region of the defined seating section, to control transmission power of the Bluetooth radios of those VDUs in a direction that decreases difference between the numbers of VDUs in their respective detected sets which are identified in information obtained from those VDUs,
wherein the operation to control transmission power of the Bluetooth radios of those VDUs comprises to:
reduce by a first step size the transmission power of the Bluetooth radios of VDUs that are located in a defined part of the cabin seating section; and
reduce by a second step size the transmission power of the Bluetooth radios of VDUs that are not located in the defined part of the cabin seating section, wherein the second step size is greater than the first step size.

8. The vehicle entertainment system of claim 1, wherein the operations of the processing circuit further comprise to:
repetitively perform the operations sequentially starting with the VDUs located at passenger seats in a defined cabin seating section and progressing toward the VDUs located at passenger seats in a more distant region of the defined seating section, to control transmission power of the Bluetooth radios of those VDUs in a direction that decreases difference between the numbers of VDUs in their respective detected sets which are identified in information obtained from those VDUs,
wherein the operation to control transmission power of the Bluetooth radios of those VDUs comprises to:
reduce by a first step size the transmission power of the Bluetooth radios of VDUs that are determined to be serving passengers having a preferentially treated status; and
reduce by a second step size the transmission power of the Bluetooth radios of VDUs that are determined to not be serving passengers having the preferentially treated status, wherein the second step size is greater than the first step size.

9. The vehicle entertainment system of claim 1, wherein the operations of the processing circuit further comprise to:
send max power commands to the VDUs to set transmission power of their Bluetooth radios to a highest level allowed for the Bluetooth radios; and
repetitively perform the operations sequentially starting with the VDUs located at passenger seats in a defined cabin seating section and progressing toward the VDUs located at passenger seats located in a more distant region of the defined seating section, to control transmission power of the Bluetooth radios of those VDUs in a direction that decreases difference between the numbers of VDUs in their respective detected sets which are identified in information obtained from those VDUs; and
repeat cycles of the repetitive performance of the operations to control transmission power of the Bluetooth radios of the VDUs to decrease difference between the numbers of VDUs in their respective detected sets which are identified in information obtained from those VDUs, until the differences satisfy a defined rule.

10. The vehicle entertainment system of claim 1, wherein the processing circuit is operative to obtain the information from the group of the VDUs by sending a request message to each of the VDUs requesting report of the information to the centralized Bluetooth radio manager.

11. The vehicle entertainment system of claim 10, wherein the processing circuit is operative to decrease a periodic rate at which it sends the request message to a selected one of the VDUs based on at least a threshold difference identified between a present number of VDUs identified in the information presently reported by the selected VDU to the centralized Bluetooth radio manager and a previous number of VDUs identified in the information previously reported by the selected VDU to the centralized Bluetooth radio manager.

12. The vehicle entertainment system of claim 10, wherein the processing circuit is operative to increase a periodic rate at which it sends the request message to a selected one of the VDUs based on at least a threshold difference between the number of VDUs identified in the information reported by the selected VDU to the centralized Bluetooth radio manager and the number of VDUs identified in the information reported by another selected one of the VDUs to the centralized Bluetooth radio manager.

13. The vehicle entertainment system of claim 1, wherein the processing circuit is operative to obtain the information from the group of the VDUs by receiving a periodic report from each of the VDUs containing the information.

14. The vehicle entertainment system of claim 1, wherein the processing circuit is further operative to:
process the information obtained from each VDU among the group of the VDUs to
identify, among the detected set of the VDUs having Bluetooth radios transmitting signals that are received by the Bluetooth radio of the VDU, which of the received signals are indicative of an active Bluetooth data connection between the Bluetooth radio of one of the set of VDUs and another Bluetooth device, and
determine the number of VDUs in the detected set by counting the identified active Bluetooth data connections.

15. The vehicle entertainment system of claim 14, wherein the processing circuit is further operative to determine the number of VDUs in the detected set to exclude from the count any of the received signals that are indicative of a Bluetooth advertisement.
